(19) United States
(12) Patent Application Publication
(10) Pub. No.: US 2016/0266043 A1
(43) Pub. Date: Sep. 15, 2016

(54) MODULAR DEVICE FOR REMOTE CHEMICAL MATERIAL ANALYSIS

(71) Applicant: VYSOKÉ UCENI TECHNICKÉ V BRNE, Brno (CZ)

(72) Inventors: Jan NOVOTNÝ, Bílovice nad Svitavou (CZ); Jozef KAISER, Kurim (CZ); Jan PROCEK, Brno - Královo Pole (CZ); Michal BRADA, Krnov-pod Bezrucovým Vrchem (CZ); Michal PETRILAK, Brno - Cerná Pole (CZ); Ivan KRUPKA, Brno (CZ)

(21) Appl. No.: 14/394,445

(22) PCT Filed: Sep. 1, 2014
(86) PCT No.: PCT/CZ2014/000095

§ 371 Date: Oct. 14, 2014

(30) Foreign Application Priority Data
Oct. 30, 2013 (CZ) PV 2013-771

(51) Int. Cl. G01N 21/71; G01N 21/17

(52) U.S. Cl. CPC G01N 21/718; G01N 21/17; G01N 2021/1793; G01N 2201/024; G01N 2201/086

(57) ABSTRACT

A modular device for remote chemical material analysis with a basic function unit which is formed with a transport module, which is partly equipped with a mobile frame construction which is set up with at least a power supply of the laser, a detection system, designed for plasma radiation dispersion according to the wavelength and its record, a control and evaluation block in the form of PC and a control electronic block and partly is connected with a laser module which contains a laser head, which serves as a source of laser pulses, where the essence of the invention is that the laser module is equipped with a laser beam router of optional routing of laser pulses either into a stand-off module when analyzed with a “Stand-Off LIBS” method or into a fiber module when analyzed with a “Remote LIBS” method.

### ART DOMAIN

This invention concerns construction of a modular device for a remote chemical material analysis done with a method of spectroscopy of laser induced plasma.

### PRESENT PRIOR ART

One from the methods which are used for a chemical material analysis is a method of spectroscopy of laser induced plasma, referred to as LIBS (Laser-Induced Breakdown Spectroscopy), which is based on principles of atomic emission spectroscopy (AES). For determination of composition of elements is used a spectral analysis of plasma radiation which is formed on the surface of the sample by a focused laser pulse. Sharp emission lines in the spectrum signalize presence of corresponding elements in the material of the sample, whereas detection limits range even on the order of units of ppm. Popularity of this method is due to its advantages it offers in comparison with other techniques of chemical material analysis. It is especially the ability to analyse samples of all states and sizes without any special preparation, whereas the results of the measurement are at disposal virtually in real time. The basic principles of this method are described, for instance, in publication RADZIEMSKI, L. J. CREMERS, D. Handbook of Laser-induced Breakdown Spectroscopy, John Wiley & Sons. 2006. 283p. ISBN 0-470-09299-8,

Generally the device for analysis with LIBS methods consists of a pulse laser for induction of the plasma on the surface of the sample, an optical system for focusing of a laser pulse, an optical system for collecting of plasma radiation, a detection system for dispersion of plasma radiation according to wavelength and its record, a device for synchronisation of pulse laser and a detection system. The principle which uses electromagnetic radiation as an energy and signal carrier enables modification of the LIBS method for remote analysis and in-situ analysis (i. e. in out-of-laboratory conditions). Therefore it is possible to analyse even the objects for which would be the classical chain of procedures, i.e. taking of sample and its transport, only feasible with difficulty or danger or would from many other reasons lack sense.

The systems for a remote analysis with the LIBS method are possible to divide into two groups. The first uses for transfer of electromagnetic radiation optical fibers and it is called “Remote LIBS”, the second uses for transfer of electromagnetic radiation direct visibility of the sample and is called “Stand-Off LIBS”. “Remote LIBS” is characterised by smaller ablation craters and by possibility to analyze samples which are not directly visible, but it is possible to approach them with an optical fiber. The “Stand-Off LIBS” analysis offers possibility to use virtually unlimited high energies and herewith to increase detection limits of the elements with lower concentration. It is possible to analyse samples which are not within reach of the optical fiber only based on direct visibility. Disadvantages are generally lower values of obtained signal with regard to noise and simultaneously higher order size of an ablation crater, which is described for example in publication FORTES, F. J., LASERNA, J. J. The development of fieldable laser-induced breakdown spectrometer: No limits on the horizon. Spectrochimica Acta Part B-Atomic Spectroscopy. 2010, vol. 65 no. 12, p. 975-990. Despite both methods complete each other suitably, by their principles and advantages, there is not known any device which would simply combine both variants and herewith extend its field of activity.

There are known other devices according to the file U.S. Pat. No. 7,092,087, where is described a particular application of LIBS device with ability to detect cancer from the sample, and according to the file US 20030147072 where is described particular application of LIBS device with ability to detect radioactive contamination. The construction of these devices, as it is described, does not allow analysis with both methods i.e. “Stand-Off LIBS” and “Remote LIBS” and does not contain a laser beam router, which would enable to route laser pulse in the way to enable both these method to use common source of the laser pulse.

In the file U.S. Pat. No. 8,125,627 is then described device, which enables to carry out the analysis with “Stand-Off LIBS” method, but it is not designed as a modular. It does not contain parts which enable analysis with “Remote LIBS” method and also not a laser beam router, which would enable to route the laser pulse in the way to be able to use common source of a laser pulse for analysis with “Stand-Off LIBS” or “Remote LIBS” method. The device is equipped with a secondary laser, a Raman spectroscope and other special components, which results in its design complexity and increased purchase costs. In the files US2011080577 and US2012062874 are described devices with use of two detectors, from which at least one detects Raman spectrum, which likewise results in more complex construction and impossibility to use these devices as a modular unit for LIBS analysis with both methods.

The aim of the presented invention is to introduce new device, whose construction enables, thanks to its modular setup, to combine measurement with the “Stand-Off LIBS” method or the “Remote LIBS” method and namely thanks to design of the laser beam router, which routes laser pulse and enables to use common source of laser beam for both methods of measurement.

### THE ESSENCE OF THE INVENTION

The defined goal is reached with an invention which is a modular device for remote chemical material analysis with a basic function unit which is formed with a transport module, which is partly equipped with a mobile frame construction, which is setup with at least a power supply of the laser, a detection system, which is designed for dispersion of the plasma radiation according to the wavelength and its record, a control and evaluation block in the form of PC and with a control electronic block'and partly is connected with a laser module, which contains a laser head, which serves as a source of laser pulses. The essence of the invention is the fact that the laser module is equipped with a laser beam router of optional routing of laser pulses either into a stand-off module, when is carried out “Stand-Off LIBS” method or into a fiber module when is carried out “Remote LIBS” method.

In an advantageous design of the device the laser module is equipped with fixation elements for possible demountable fixation either to the frame construction of the transport module or into the stand-off module.

For usage when analyzed with the “Stand-Off LIBS” method at direct visibility of the sample from the transport module the stand-off module is formed with at least a stand-off primary optical system, designed for focusing of laser pulses onto the sample, a stand-off secondary optical system, designed for collecting of emitted electromagnetic radiation, a scan camera and a distance meter system, whereas with the laser module is the stand-off module disconnectable connected by the help of a connecting element for laser pulses routing and with the transport module by the help of a stand-off collecting cable for routing of electromagnetic radiation.

In an optimal design of the device, for a possibility of setup or demountable setup on the frame construction of the transport module, the stand-off module is equipped with the connecting member, whereas the transport module is procured with an in shape and size corresponding fixation platform.

Further is advantageous when the fiber module for usage of the device for analysis with “Remote LIBS” method consists of a fiber primary optical system designed for focusing of the laser pulse and of a fiber secondary optical system designed for collection of emitted electromagnetic radiation, whereas the fiber module ,is with the laser module disconnectable connected through an optical cable for routing of laser pulses and with the transport module by the help of a fiber collecting cable for routing of electromagnetic radiation.

With this presented invention is reached new and higher efficiency in that, that by the help of construction members, which enable connection and disconnection of the transport module and stand-off or fiber module without use of tools, this device enables to combine both remote variants “Stand-Off LIBS” and “Remote LIBS” and herewith, contrary to the existing solutions, enables remote analysis of the objects based on direct visibility and at the same time analysis of poorly accessible objects by the help of a fiber detection probe. At the same time the device can be, due to dependence on the planned application, simply setup with a “Stand-Off LIBS” module, “Remote LIBS” module or with both of them. The device likewise enables to use common source of laser beam for both methods of chemical analysis, and thus decreases weight of the device and its production costs, and its modularity provides user possibility to transport to the place of analysis only one from the modules, which also decreases transport requirements.

### DESCRIPTION OF FIGURES IN ENCLOSED DRAWINGS

A particular design of the invention is schematically illustrated in enclosed drawings where:

FIG. 1 illustrates a general block scheme of the device with illustration of possible connection of functional modules for realization of “Stand-Off LIBS” method and also of “Remote LIBS” method and their mutual bindings,

FIG. 2 illustrates configuration of the device with a stand-off module for realization of “Stand-Off LIBS” method in the form of a simplified block scheme and

FIG. 3 illustrates configuration of the device with a fiber module for realization of “Remote LIBS” method also in the form of a simplified block scheme.

The drawings which illustrate presented invention and consequently described examples of particular design do not in any case anyhow limit the extend of the protection which is mentioned in the definition yet only clarify the essence of the invention.

### EXAMPLES OF REALIZATION OF THE INVENTION

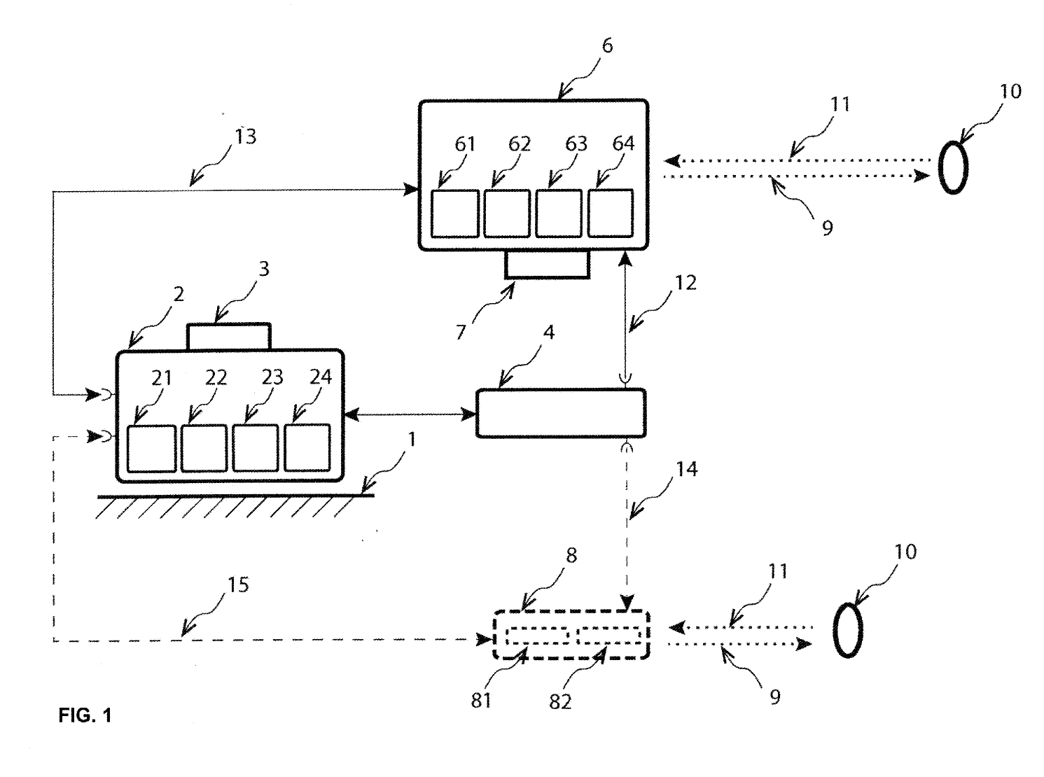

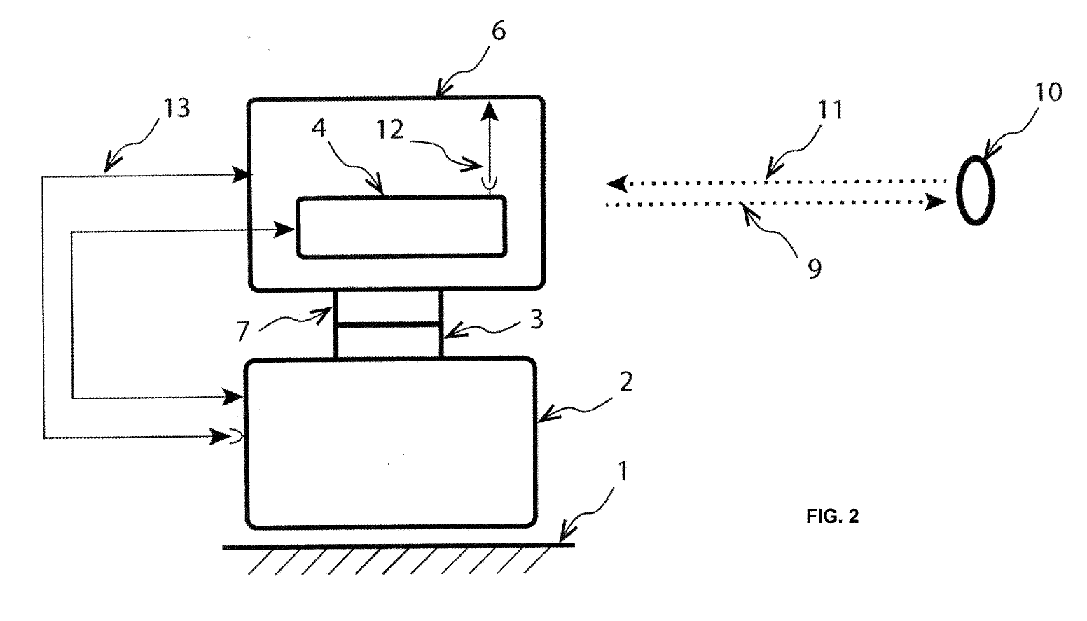

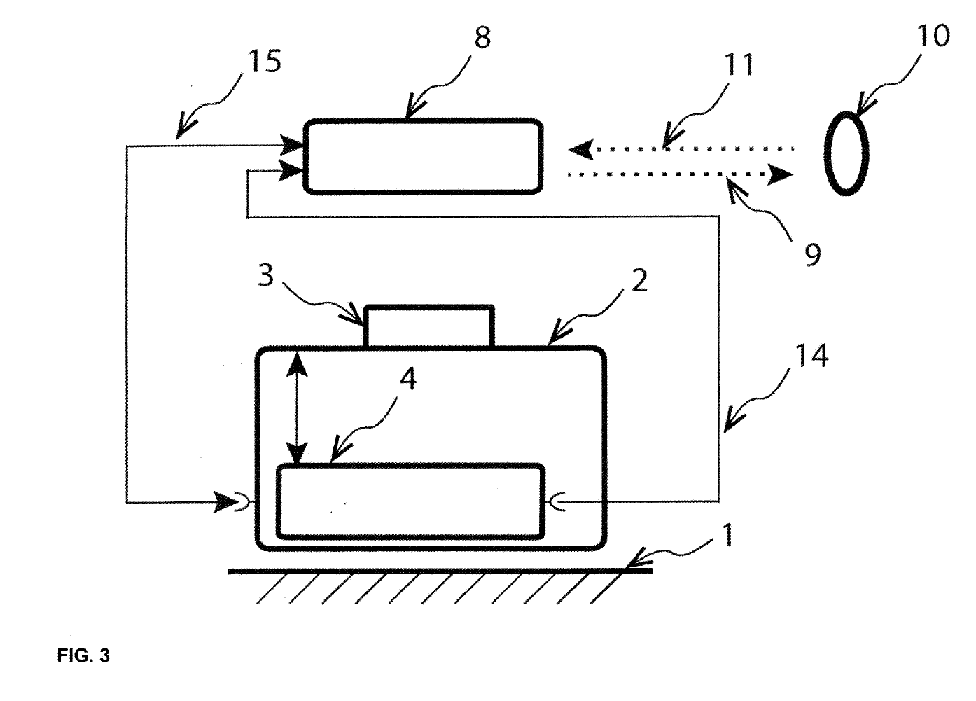

The basic function unit of an objective modular device for remote chemical material analysis is a transport module 2 which is formed with a more closely non-illustrated frame construction, which is procured with likewise non-illustrated travel means, for instance wheels, to enable its movement on the surface 1 in any direction and possibly with stabilisation feet for provision of a fixed position of the transport module 2 on chosen place of this surface 1. The transport module 2 is setup with mutually connected basic function elements which are necessary for provision of realization of a remote chemical analysis namely at least with a power supply 21 of the laser, a detection system 22 for dispersion of plasma radiation according to wavelength and its record, a control and evaluation block 23 in the from of PC and a control electronic block 24 as it is illustrated in FIG. 1. The transport module 2 is via a cable connected to a laser module 4 which consists of a laser head 41, which serves as a source of laser pulses, and of a laser beam router 42 which is procured with non-illustrated standard function elements which enable routing of laser pulses either into a stand-off module 6 or into a fiber module 8. The laser module 4 is also equipped with more closely unspecified fixation elements in the form of fixtures, which enable in dependence on option of measurement method “Stand-Off LIBS” or “Remote LIBS” its variable demountable fixation with non-illustrated fixation elements, either to the frame construction of the transport module 2 or into the stand-off module 6 as it is illustrated in FIG. 2 and FIG. 3.

The stand-off module 6 for use when analysed with the “Stand-Off LIBS” method with direct visibility of the sample 10 from the transport module 2 is formed with at least a stand-off primary optical system 61, designed for focusing of laser pulses 9 onto the sample 10, with a stand-off secondary optical system 62, which contains a non-illustrated reflective telescope and which is designed for collection of emitted electromagnetic radiation 11, with a scan camera 63 and a distance meter system 64, wherewith is enabled to focus and route laser pulses 9 onto the surface of the sample 10 and, at the same time, to collect arisen electromagnetic radiation 11 which is emitted by the plasma. With the laser module 4 is the stand-off module 6 disconnectedly connected by the help of a connecting element 12 which routes the laser pulses 9 and with the transport module 2 by the help of a stand-off collecting cable 13 which routes electromagnetic radiation 11. To enable setup or demountable setup on the frame construction of the transport module 2 the stand-off module 6 is equipped with a connecting member 7, whereas the transport module 2 is procured with an in shape and size corresponding fixation platform 3.

A fiber module 8, for use of the device when using the “Remote LIBS” method, consists of a fiber primary optical system 81 designed for focusing of the laser pulse 9 and a fiber secondary optical system 82 designed for collection of emitted electromagnetic radiation 11, where as the stand-off module 6 enables to focus and route the laser pulses 9 onto the surface of the sample 10 and, at the same time, to collect arisen electromagnetic radiation 11 which is emitted by plasma. With the laser module 4 the fiber module 8 is disconnectedly connected via an optical cable 14 which routes laser pulses 9 and with the transport module 2 by the help of a fiber collecting cable 15, which routes electromagnetic radiation 11.

When is the modular device used for analysis with the “Stand-Off LIBS” method, the laser module 4 is placed into the stand-off module 6 which is setup on the frame construction of the transport module 2 by the help of the connecting element 7 and the fixation platform 3. By the help of a control and evaluation block 23 are laser pulses routed through a laser beam router 42 of the laser module 4 from a laser head 41 through a stand-off primary optical system 61 of a configured stand-off module 6 to the surface of the explored sample 10. The electromagnetic radiation 11 which is emitted by formed plasma is collected with a stand-off secondary optical system 62 and then routed into a detection system 22 of the transport module 2, by the help of whose members and the evaluation block 23 is evaluated spectral characteristic of the radiation 11.

When is the modular device used for analysis with the “Remote LIBS” method the laser module 4 is placed into the transport module 2. The fiber module 8 is by the help of an optical cable 14 and a fiber collecting cable 15 connected to the transport module 2 and to the laser module 4. By the help of a control and evaluation block 23 are laser pulses routed through a laser beam router 42 of the laser module 4 from a laser head 41 through a fiber primary optical system 81 of a configured fiber module 8 to the surface of explored sample 10. The electromagnetic radiation 11 which is emitted by formed plasma is collected with a fiber secondary optical system 82 and then directed into a detection system 22 of the transport module 2, by the help of whose members and the evaluation block 23 is evaluated spectral characteristic, of radiation 11.

### INDUSTRIAL USABILITY

A modular device for remote chemical material analysis according to the presented invention is usable in many branches of science and industry, for example for control of quality and contamination of materials in steelwork industry and energy industry, for environment diagnostics, heavy metal detection in biological samples, detection of minerals and miners in geology, element analysis in space research or in civil defence for detection of substances at contamination of the environment.

1. A modular device for remote chemical material analysis with a basic function unit which is formed with a transport module, which is partly equipped with a mobile frame construction which is setup with at least a power supply of the laser, a detection system, designed for plasma radiation dispersion according to the wavelength and its record, a control and evaluation block in the form of PC and a control electronic block, and partly is connected with a laser module which contains a laser head, which serves as a source of laser pulses, wherein the laser module is equipped with a laser beam router of optional routing of laser pulses either into a stand-off module when analyzed with a “Stand-Off LIBS” method or into a fiber module when analyzed with a “Remote LIBS” method.

2. The modular device according to claim 1, wherein the laser module is equipped with fixation elements for possible demountable fixation either to the frame construction of the transport module or into the stand-off module.

3. The modular device according to claim 1, wherein the stand-off module for usage when analyzed with the “Stand-Off LIBS” method at direct visibility of the sample from the transport module is formed with at least a stand-off primary optical system designed for focusing of the laser pulses onto the sample, a stand-off secondary optical system designed for collection of emitted electromagnetic radiation, a scan camera and a distance meter system.

4. The modular device according to claim 3, wherein with the laser module is disconnectable connected the stand-off module by the help of a connecting element for routing of the laser pulses and with the transport module by the help of a stand-off collecting cable for routing of electromagnetic radiation.

5. The modular device according to claim 3, wherein, for possibility of setup or demountable setup on the frame construction of the transport module, the stand-off module is equipped with a connecting member, whereas the transport module is procured with an in shape and size corresponding fixation platform.

6. The modular device according to claim 1, wherein a fiber module for use of the device for analysis with the “Remote LIBS” method consists of a fiber primary optical system, designed for focusing of the laser pulse and from a fiber secondary optical system, designed for collection of emitted electromagnetic radiation.

7. The modular device according to claim 6, wherein with the laser module is the fiber module disconnectable connected via an optical cable for routing of the laser pulses and with the transport module by the help of a fiber collecting cable for routing of electromagnetic radiation.
